(19) United States
(12) Patent Application Publication
(10) Pub. No.: US 2004/0098499 A1
(43) Pub. Date: May 20, 2004

(54) Load balancing system

(76) Inventor: Hiroaki Tamai, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/701,926

(22) Filed: Nov. 5, 2003

(30) Foreign Application Priority Data
Nov. 5, 2002 (JP) 2002-321326

(51) Int. Cl. G06F 15/16

(52) U.S. Cl. 709/232

(57) ABSTRACT

A load balancing system provided with at least one first load balancing apparatus for analyzing higher layer information included in a received packet to generate attribute information of the received packet and transmitting the packet given that attribute information, a second load balancing apparatus for determining an optimal server for allocation of the packet based on traffic status information of packets and the attribute information sent from the at least one first load balancing apparatus and transmitting the packet to the server, and, optionally, a third load balancing apparatus for allocating the received packet to any of a plurality of first load balancing apparatuses, whereby it becomes possible to reduce as much as possible the intercommunication required for load balancing in the system and to obtain a performance proportional to the number of load balancing apparatuses.

### BACKGROUND OF THE INVENTION

1. Field of the Invention

The present invention relates to a load balancing system, more particularly relates to a load balancing system for allocating a packet (service request) transmitted from a client through a network to a suitably selected server of a plurality of servers.

2. Description of the Related Art

In recent years, in response to the increasing complexity and increasingly large scale of services in networks, servers are being strongly pressed to be function higher in performance. To deal with this, the technique of “load balancing”, that is, the provision of a plurality of servers and performing processing by dispersing the services among the plurality of servers, has been generally adopted.

For example, U.S. Pat. No. 6,097,882, U.S. Pat. No. 5,774,668, Japanese Unexamined Patent Publication (Kokai) No. 2001-101134, Japanese Unexamined Patent Publication (Kokai) No. 2001-167074, Japanese Unexamined Patent Publication (Kokai) No. 2002-141936, and Japanese Unexamined Patent Publication (Kokai) No. 2003-152783 and Japanese Patent Application No. 2001-372836 etc. filed by the present assignee disclose related art for realizing such load balancing. Among these, U.S. Pat. No. 6,097,882, Japanese Patent Application No. 2001-372836, and U.S. Pat. No. 5,774,668 will be explained in detail later with reference to FIG. 14, FIG. 15, FIG. 16, and FIG. 17.

The load balancing system according to U.S. Pat. No. 6,097,882, shown in FIG. 14, analyzes a packet received from an external network to determine one or more servers able to process the packet. When there are a plurality of candidate servers at that time, it allocates the packet to the single most suitable server as seen from the processing performance of the servers, for example, the throughput or call processing capability.

The load balancing system according to Japanese Patent Application No. 2001-372836, shown in FIG. 15 and FIG. 16, provides a plurality of load balancing apparatuses (α1 . . . αN) corresponding to the load balancing apparatus (α) shown in FIG. 14 and provides a simple load balancing apparatus (β) for allocation use in front of these apparatuses (α1 . . . αN).

Further, the load balancing system according to U.S. Pat. No. 5,774,668, shown in FIG. 17, enables any of the load balancing apparatuses (α1 . . . αN) shown in FIG. 15 and FIG. 16 to allocate packets to any server.

Summarizing the problems to be solved by the invention, there were problems in U.S. Pat. No. 6,097,882, Japanese Patent Application No. 2001-372836, and U.S. Pat. No. 5,774,668 as will be explained with reference to FIG. 14, FIG. 15, FIG. 16, and FIG. 17.

In U.S. Pat. No. 6,097,882 (FIG. 14), when a request arose for complicated processing for the analysis of a packet in the load balancing system, the processing performance of the system as a whole ended up being determined by the processing performance of the load balancing apparatus α. As a result, there was the first problem that the load balancing apparatus α became a bottleneck in improving the processing performance of the system.

Further, in Japanese Patent Application No. 2001-372836 (FIG. 15 and FIG. 16), there was the second problem that when a certain load balancing apparatus (for example, α1) became overloaded, even if there were extra capacity in the processing performance of the group of servers under that apparatus (α1), the system could only be run up to the processing capability right before the apparatus (α1) became overloaded. At this time, if resolving this overload by providing another new load balancing apparatus in addition to the load balancing apparatuses (α1 . . . αN), there was the third problem that in order to run the increased load balancing apparatus as desired, it would be necessary to add a predetermined number of servers regardless of the fact that there was extra processing capability of the group of servers of the system as a whole as explained above.

Further, in U.S. Pat. No. 5,774,668 (FIG. 17), since a plurality of load balancing apparatuses (α1 . . . αN) are connected to each server, competition must not occur in allocation of packets among these load balancing apparatuses. Therefore, all of the load balancing apparatuses have to share the same allocation information at all times. That is, there is the fourth problem that it is necessary for each of the load balancing apparatuses to constantly communicate with all of the servers or for all of the load balancing apparatuses to communicate among themselves to share information. In addition, to evenly distribute packets among all servers, it is necessary for each server to constantly provide all of the load balancing apparatuses with information on its status. There is therefore the fifth problem that the amount of communication required becomes considerably large.

### SUMMARY OF THE INVENTION

An object of the present invention is to provide a load balancing system able to greatly lighten the load in a system required for load balancing, that is, the load relating to communication required for collecting status information from the servers, and able to give a system performance straightforwardly proportional to the number of load balancing apparatuses.

To attain the above object, according to the present invention, there is provided a load balancing system provided with at least one first load balancing apparatus (11) for analyzing higher layer information included in a received packet to generate attribute information of the received packet and transmitting the packet given that attribute information, a second load balancing apparatus (12) for determining an optimal server for allocation of the packet based on traffic status information of packets and the attribute information sent from the at least one first load balancing apparatus (11) and transmitting the packet to the server, and, optionally, a third load balancing apparatus (13) for allocating the received packet to any of a plurality of first load balancing apparatuses, whereby it becomes possible to reduce as much as possible the intercommunication required for load balancing in the system and to obtain a performance proportional to the number of load balancing apparatuses.

### BRIEF DESCRIPTION OF THE DRAWINGS

These and other objects and features of the present invention will become clearer from the following description of the preferred embodiments given with reference to the attached drawings, wherein:

FIG. 1 is a view of the basic configuration of a load balancing system according to the present invention;

FIG. 2 is a view showing the basic configuration of FIG. 1 in more detail;

FIG. 3 is a view of a tag (AID, TID, TEF) buried in part of a packet;

FIG. 4 is a view of a first table according to the present invention;

FIG. 5 is a view of a second table according to the present invention;

FIG. 6 is a view of a third table according to the present invention;

FIG. 7 is a functional block diagram of a packet allocating means 18 shown in FIG. 2;

FIG. 8 is a functional block diagram of a packet analyzing means 15 shown in FIG. 2;

FIG. 9 is a functional block diagram of a server selecting means 16 shown in FIG. 2;

FIG. 10 is a first part of a flow chart of the operation of a load balancing apparatus 12 when receiving a packet from a load balancing apparatus 11;

FIG. 11 is a second part of a flow chart of the operation of a load balancing apparatus 12 when receiving a packet from a load balancing apparatus 11;

FIG. 12 is a flow chart of the operation of the load balancing apparatus 12 when a server has degenerated;

FIG. 13 is a flow chart of the operation of the load balancing apparatus 12 when a server has been restored from a degenerated state;

FIG. 14 is a view of a related art;

FIG. 15 is a first part of another related art;

FIG. 16 is a second part of the other related art; and

FIG. 17 is a view of still another related art;

### DESCRIPTION OF THE PREFERRED EMBODIMENTS

Preferred embodiments of the present invention will be described in detail below while referring to the attached figures.

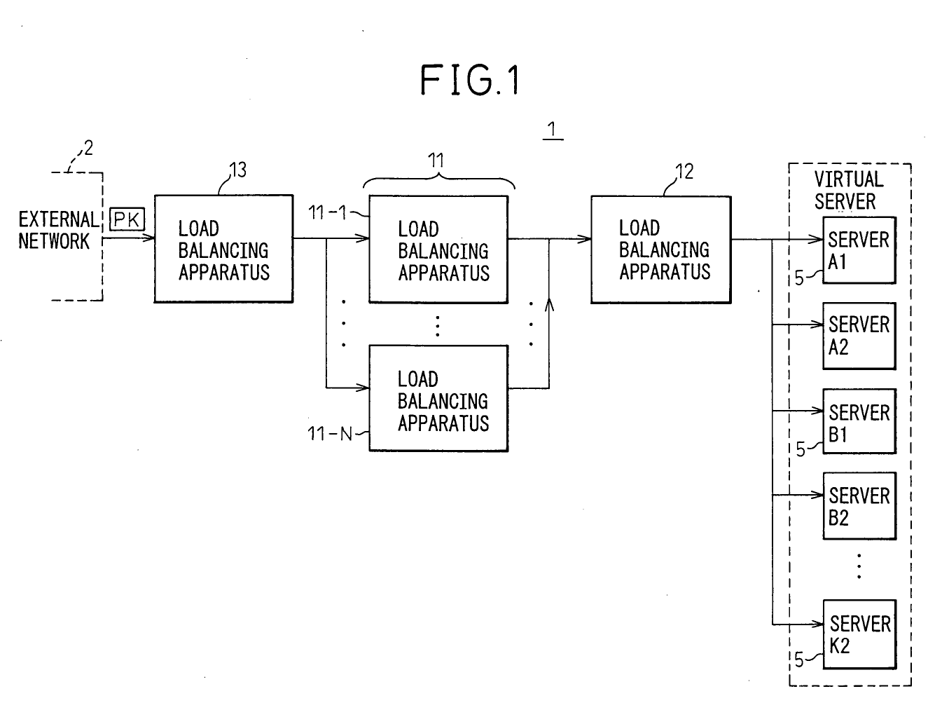

FIG. 1 is a view of the basic configuration of a load balancing system according to the present invention. Note that throughout the figures, the same components are assigned the same reference numerals or symbols.

In the figure, the main components of the load balancing system 1 of the present invention are first load balancing apparatuses 11 and a second load balancing apparatus 12. Preferably, a third load balancing apparatus 13 is provided in front of the first load balancing apparatuses 11.

Each of the first load balancing apparatuses 11 analyzes higher layer information included in a received packet PK received from an external network 2 side, that is, a client side, to identify an application of the received packet, generates attribute information for discriminating the transaction, and transmits the packet with the attribute information attached. The second load balancing apparatus 12 monitors the state of traffic of the packets transmitted to the servers 5 connected under it in correspondence with the servers 5, determines the optimum server for allocation of a packet based on the traffic state information and attribute information transmitted from the first load balancing apparatuses 11, and transmits the packet to the determined server.

More specifically, the load balancing system 1 is comprised of a plurality of first load balancing apparatuses 11-1 to 11-N and a second load balancing apparatus 12 shared by these first load balancing apparatuses and is further provided with a third load balancing apparatus 13 for allocating a received packet PK in accordance with a predetermined algorithm based on hash computation etc. to one of the plurality of first load balancing apparatuses 11-1 to 11-N.

The amount of processing required for analysis of the above higher layer information is large, so this processing is preferably dispersed among the plurality of first load balancing apparatuses 11-1 to 11-N. For this, the third load balancing apparatus 13 becomes necessary.

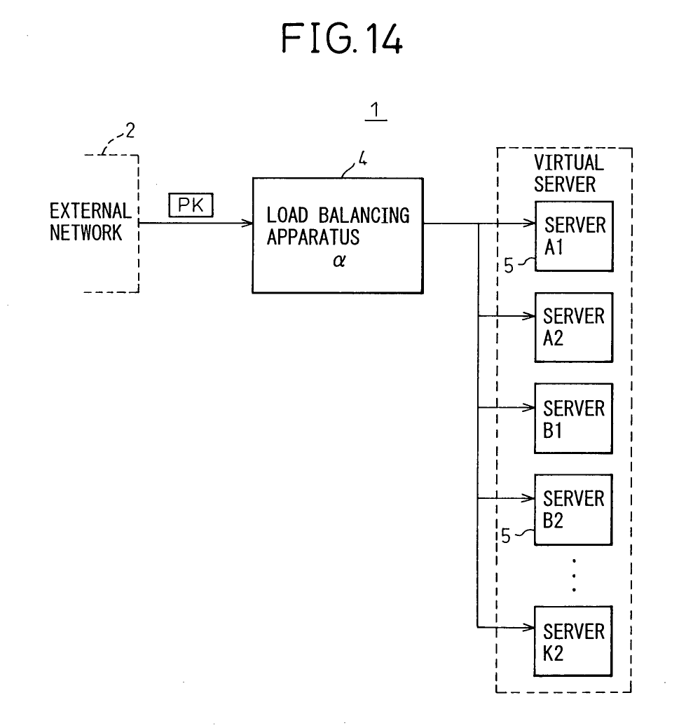

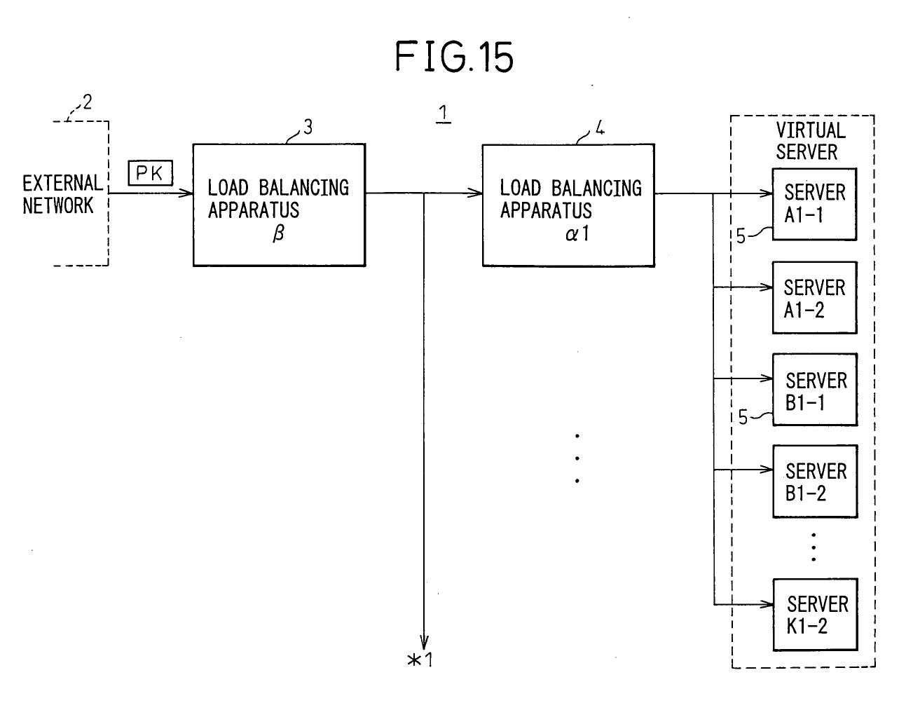

That is, to enable the load balancing apparatuses 11-1 to 11-N to operate dispersed while sharing allocation information without using the system network, function of a packet analysis and function of load balancing through server processing performance handled by the load balancing apparatus α, as in the related art shown in FIG. 14 to FIG. 17, are divided into function of packet analysis handled by first load balancing apparatuses 11 and function of load balancing through server processing performance handled by a second load balancing apparatus 12, as shown in FIG. 1, where the processing of the apparatuses 11, which became the aforesaid bottleneck in system performance, is dispersed to a plurality of apparatuses, and the processing of the apparatus 12 is centralized.

Therefore, according to the present invention, it becomes possible to realize a load balancing system able to greatly reduce the load in the system required for load balancing, that is, the load due to communication required for collecting status information from the servers 5, and to obtain a system performance straightforwardly proportional to the number (N) of load balancing apparatuses 11-1 to 11-N.

Next, embodiments according to the present invention will be explained. Before this, however, FIG. 14 to FIG. 17 concerning the related art described above will be explained.

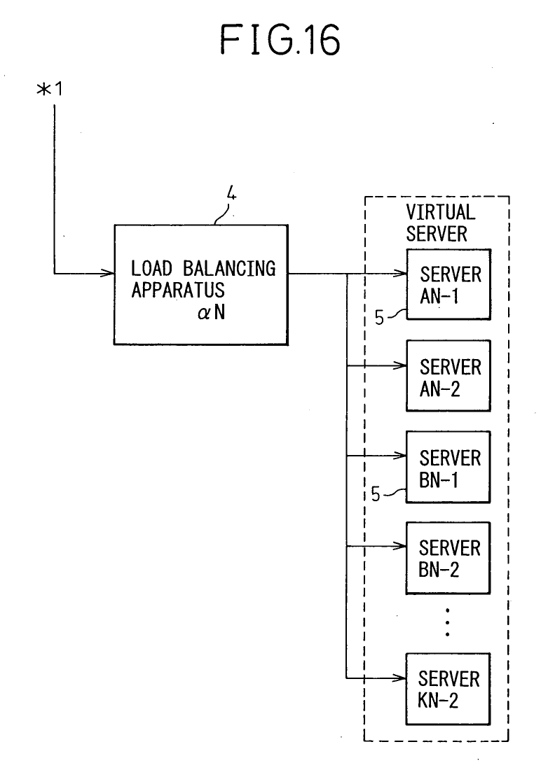

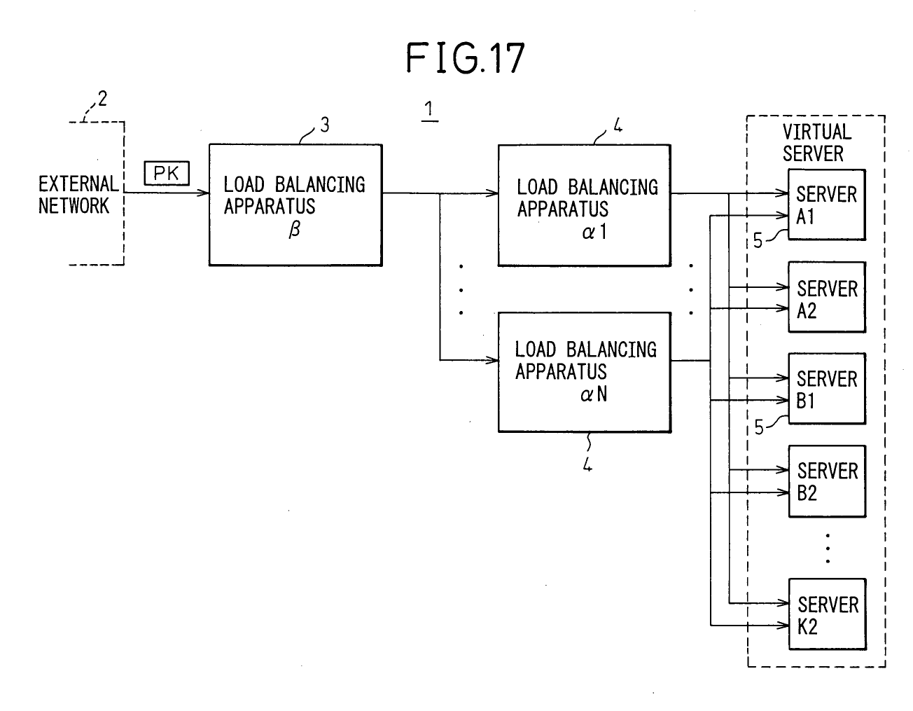

FIG. 14 is a view of the related art of U.S. Pat. No. 6,097,882, FIG. 15 and FIG. 16 are first and second parts of a view of the related art of Japanese Patent Application No. 2001-372836, and FIG. 17 is a view of the related art of U.S. Pat. No. 5,774,668.

First, referring to FIG. 14, the load balancing system 1 according to the related art of U.S. Pat. No. 6,097,882 is mainly configured by a load balancing apparatus (α) 4 analyzing an IP address given to a packet PK sent from a client (not shown) through the Internet, an intranet, or other external network 2 and allocating the packet to a suitable server 5.

That is, as explained above, a packet PK received from the external network 2 is analyzed, one or more servers 5 able to process the packets are determined, and, when there are a plurality of such servers (candidates), the single most suitable server judging from the processing performance of the servers 5, for example, the throughput or call processing capability, is allocated to accept the packet PK. According to this related art, however, the above-mentioned first problem arose.

Note that in the figure, the letters A, B . . . K attached to the servers 5 indicate types of applications to be executed by the servers. Further, the numerals 1 and 2 attached to the letter A such as in A1 and A2 are numbers for differentiating between for example two servers executing the same application A.

Next, referring to FIG. 15 and FIG. 16, the load balancing system 1 according to the related art of Japanese Patent Application No. 2001-372836 is comprised of not a single load balancing apparatus 4 using a simple algorithm such as in FIG. 14 using IP addresses, but a plurality of high performance load balancing apparatuses, arranged in parallel, operated by using advanced XML (extensible Markup Language) or Layer 7 information.

Further, a load balancing apparatus (β) 3 using a simple algorithm is further added for selecting a single suitable apparatus from these plurality of parallel arranged load balancing apparatuses 4. According to this related art, however, the above-mentioned second and third problems were caused.

Further, referring to FIG. 17, in the load balancing system 1 according to the related art of U.S. Pat. No. 5,774,668, a plurality of parallel arranged load balancing apparatuses (α1 . . . αN) are configured to be able to share all servers 5. Therefore, in the system 1 of this related art, there is the advantage that the second problem and third problem in the above related art (FIG. 15 and FIG. 16) can be solved. On the other hand, however, the above-mentioned fourth and fifth problems end up being caused.

Therefore, the present invention provides a load balancing system free from all of the problems inherent to the above related art. Embodiments will be described in detail below.

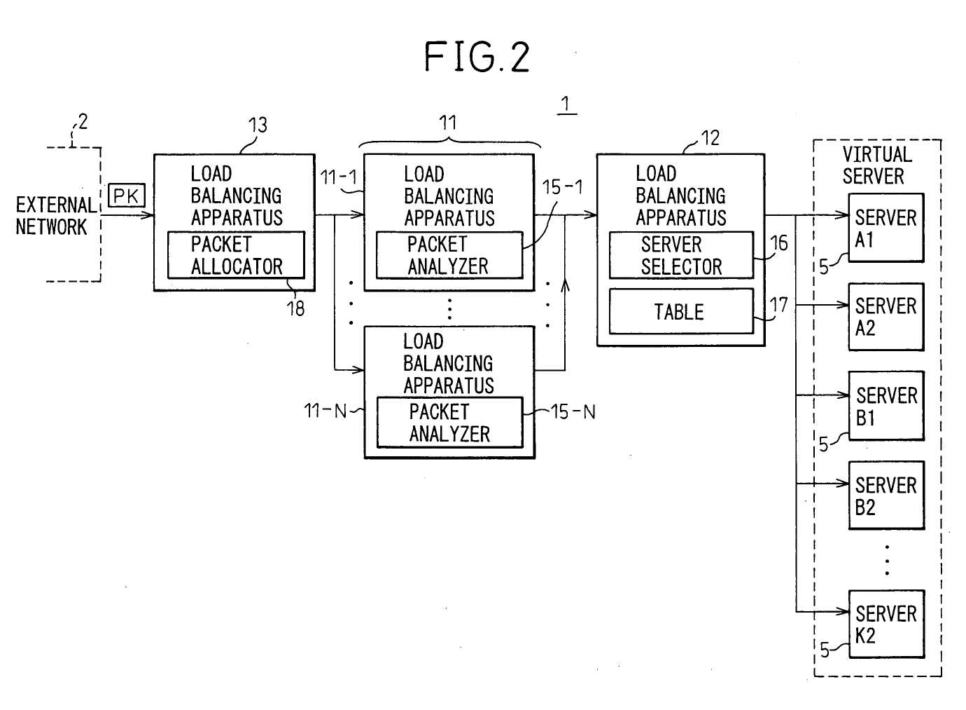

FIG. 2 is a view showing the basic configuration of FIG. 1 in further detail. In the figure, packet analyzing means 15 (15-1 to 15-N), a server selecting means 16, and a table 17 are newly illustrated.

Each of the first load balancing apparatuses 11 has a packet analyzing means 15. Each packet analyzing means 15 generates identification information for identifying an application by higher layer information and discrimination information for discriminating a series of transactions relating to the application and further generates end information when the series of transactions ends. Further, it attaches the information to the received packet PK and sends the result to the second load balancing apparatus 12.

Each packet analyzing means 15 assigns discrimination information to a packet each time a series of transactions is started. While a series of transactions is in progress, the same discrimination information is used. When the series of transactions ends, that discrimination information is released.

On the other hand, the second load balancing apparatus 12 has a server selecting means 16. This server selecting means 16 acquires statistical information relating to both the flow rate of packets and the number of transactions as the above-mentioned traffic status information and identifies a group of servers 5 able to execute the application based on the received identification information. Further, it determines the optimum destination server 5 in the group of servers based on the statistical information and sends the received packet PK to the destination server.

The server selecting means 16 acquires degeneration/restoration information relating to degeneration and restoration of the servers 5 and excludes degenerating servers from coverage in the determination of the above destination server.

Further, the server selecting means 16 determines the destination server from the above discrimination information in accordance with whether a series of transactions has started, is in progress, or has ended.

Further, the server selecting means 16 updates the traffic status information in accordance with any change in the traffic status.

Further, the server selecting means 16 sends the packet to the server 5 side after stripping the attribute information, identification information, and end information added to the received packet PK.

The server selecting means 16 has various types of tables 17 for storing various types of information required for identification of the group of servers and determination of the destination server explained above.

This will be explained in further detail below.

The packet analyzing means 15 has the function of analyzing a packet to identify the application (http, FTP, etc.), of discriminating the data attribute (number of transactions large or small etc.) and of assigning an application ID (AID) as the aforementioned identification information as a result of the above discrimination. This discrimination function can be realized by a general use processor and a user algorithm.

Further, it has the function of managing the TCP session, discriminating the higher layer transaction number etc. so as to discriminate if a transaction is the same and, if the transaction is the same as a result of the discrimination, and of assigning the same transaction ID (TID) to the packet of that transaction as the above discrimination information.

Discrimination of a transaction by elements of a layer higher than TCP can be realized by a general use processor and user algorithm.

Further, it has the function of detecting the end of a transaction. The results of the detection become the above-mentioned end information. Determination of the end of a transaction by an element of a layer higher than TCP can be realized by a general use processor and user algorithm.

The packet analyzing means 15 notifies the results of analysis of the packet, that is, the information for identifying the application (identification information), the information for discriminating a series of transactions (discrimination information), and end information of transactions, to the server selecting means 16.

As explained above, the identification information for identifying an application is made the application ID (AID), the discrimination information for discriminating a series of transactions is made the transaction ID (TID), and the end information of transactions is made the transaction end flag. These are embedded as a tag (comprised of AID, TID, and transaction end flag (TEF)) in part of the packet and notified to the server selecting means 16.

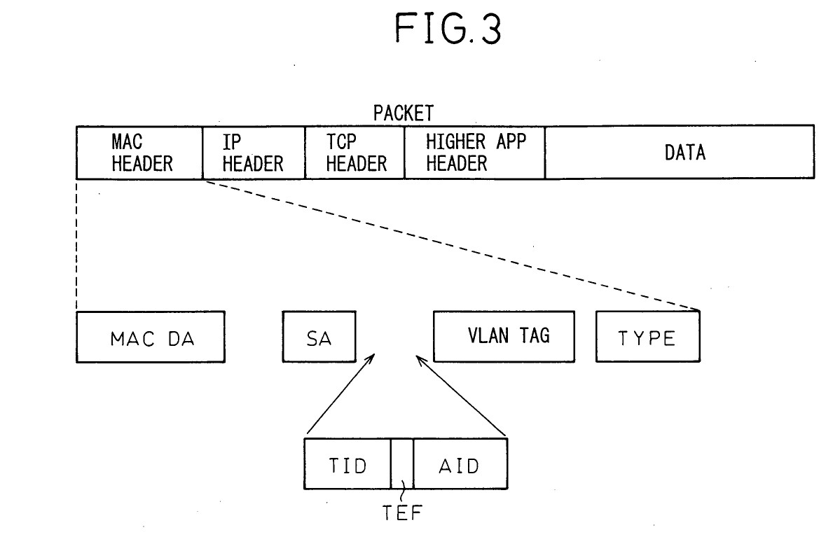

FIG. 3 is a view of the positioning of the above-mentioned tag. This is however just one example.

According to the illustrated example, each packet is comprised of a media access control (MAC) header, Internet protocol (IP) header, transmission control protocol (TCP) header, higher application (APP) header, and data. Further, the MAC header is comprised of a MAC-destination address (DA), a source address (SA), a virtual LAN (VLAN) tag, and a type (TYPE).

The above tag (AID, TEF, TID) according to the present invention can be embedded between the SA and VLAN tags in the above packet.

Returning to FIG. 2, the server selecting means 16 can achieve service (packet) processing, without linking the servers to operate together, based on (i) the above information notified from the packet analyzing means 15-1 to 15-N and (ii) information for predicting the loads of servers 5 (the number of octets allocated per second (packet length of FIG. 3), the number of starts of transactions per second, and the total number of transactions finished being allocated but not ended), so that the means can allocate packets while making the processing loads of the servers 5 equal.

To assign a series of transactions to the same server, it judges if the TID notified from the packet analyzing means 15 has finished being allocated to a specific server (that is, if a transaction has started). For this, table 17 holds a table A (first table) comprised of TIDS and IP-destination addresses (DA) of the servers.

To identify a group of servers able to process a specific application, a table B comprised of AIDS, IP-DAs of servers, and flags showing server degeneration is held in the table 17.

To identify a single server judged to have the smallest processing load at the present time from the group of servers able to process an application designated by its AID, the table 17 holds a table C which is comprised of their IP-DAs, the number of octets per second of an allocated packet corresponding to the IP-DAs, the number of transactions finished starting per second, the total number of transactions finished being allocated but not yet ended, and the number of transactions which a server can process.

To judge which allocation information should optimally be used in the table C in accordance with the characteristics of the application, a table D is held in the table 17, which is comprised of AIDs and weighting information of the allocation information.

Note that the table B and the table D both use the AID as a search key, so it is preferable to merge the tables B and D into a single table (second table).

To identify applications which a degenerated server 5 can provide when a certain server 5 degenerates, a table E comprised of IP-DA and the AID list is held in the table 17.

Note that the table C and table E match in that both use IP-DA as the search key, so it is preferable to merge the tables C and E into a single table (third table).

The first, second, and third tables explained above will be explained with reference to the drawings.

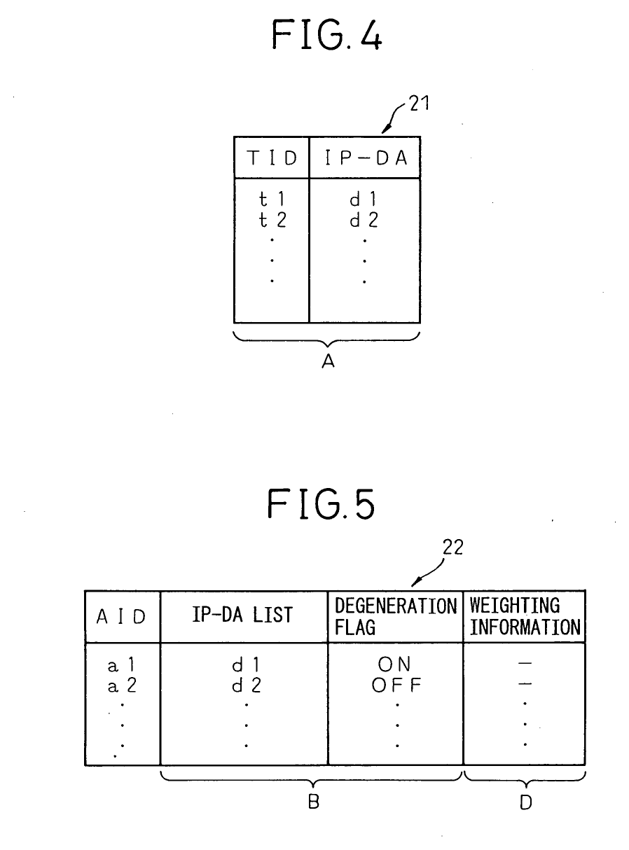

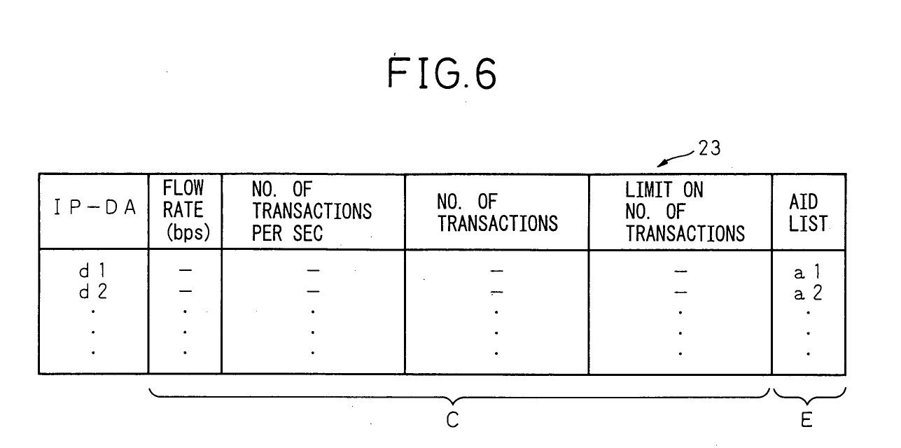

FIG. 4 is a view of a first table according to the present invention; FIG. 5 is a view of a second table according to the present invention; and FIG. 6 is a view of a third table according to the present invention.

First, referring to FIG. 4, the first table (above table A) 21 is shown. This first table 21 is a table of correspondence between assigned TIDS (identification information) and IP-DAs (destination servers).

FIG. 5 shows the second table 22 comprised of the table B and the table D merged together. The second table 22 is a table of correspondence between applications and IP-DAs of the group of servers which can process the same and registers the above information statically. That is, when information is registered at the time of initialization, it subsequently remains fixed. If a certain server degenerates or has been restored, an operation for rewriting the information becomes necessary. Further, the above-mentioned weighting information, that is, information for determining which item in the table 23 of FIG. 6 should be given priority to (stressed) in assigning servers, is also incorporated into the table 22.

FIG. 6 shows the third table 23 which is comprised of the table C and the table E merged together. This shows, for each server, the flow rate of packets, the number of transactions per second, the total number of transactions, the limit value of the number of transactions (limit value as determined by memory capacity), and the AID list.

These first, second, and third tables 21, 22, and 23 may be summarized as follows:

### First Table 21

The first table 21 indicates a correspondence between the discrimination information (TID) finished being assigned and the destination servers 5 starting the transactions.

The above correspondence is deleted from the first table 21 when the end information (TEF) is ON.

### Second Table 22

The second table 22 indicates a correspondence between the identification information (AID) and the servers able to process the application.

The second table 22 is referred to when the received packet PK has not yet been assigned the discrimination information (TID).

The second table 22 also indicates the degeneration/restoration information (degeneration flag) of the servers corresponding to the servers (IP-DA) able to process the application.

The second table 22 may also indicate weighting information designating statistical information (content of third table 22) to be stressed on a priority basis when determining the optimal destination server corresponding to the identification information (AID).

### Third Table 23

The third table 23 indicates the statistical information (flow rate and number of transactions) corresponding to the destination servers (IP-DAs). It refers to the statistical information to assign a destination server with a small processing load when determining the optimal destination server. Note that the third table 23 is referred to when there is correspondence between the discrimination information (TID) finished being assigned and destination servers (IP-DAs) starting transactions in the first table 21.

The third table 23 also indicates an identification information list (AID list) corresponding to the destination servers (IP-DA). It registers processable applications and data attributes for each destination server in the identification information list (AID list).

Next, an example of the group of blocks for realizing the functions of the server selecting means 16 (FIG. 2) cooperating with the second and third tables (17) and the packet analyzing means 15 cooperating with the server selecting means 16 (FIG. 2) will be shown together with the packet allocating means 18 in the third load balancing apparatus 13. In practice, however, the functions can be realized by software processing using a CPU.

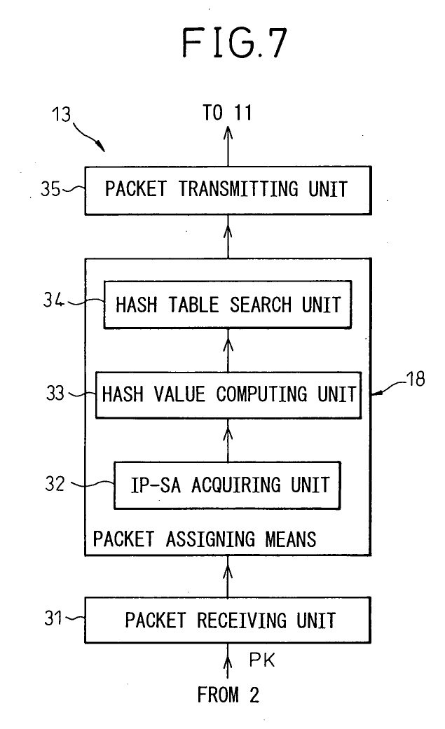

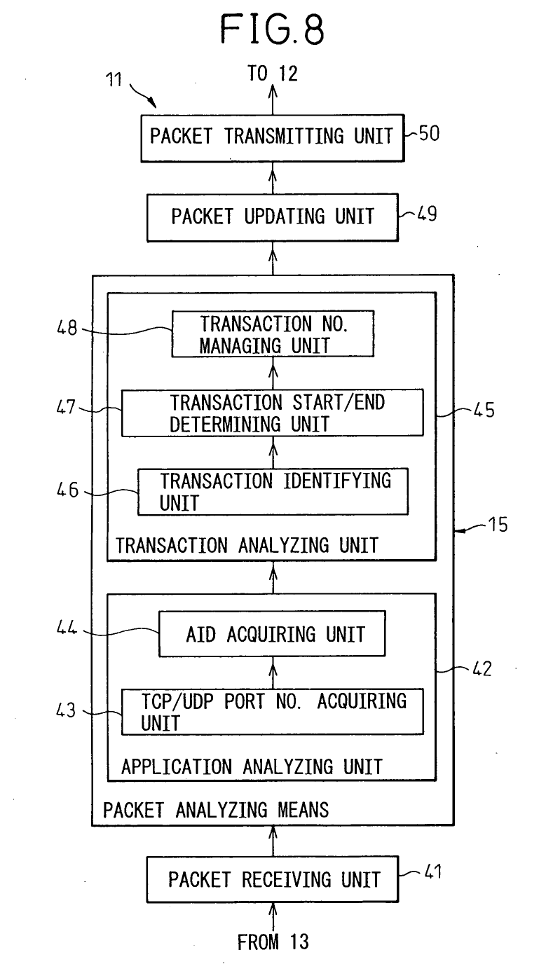

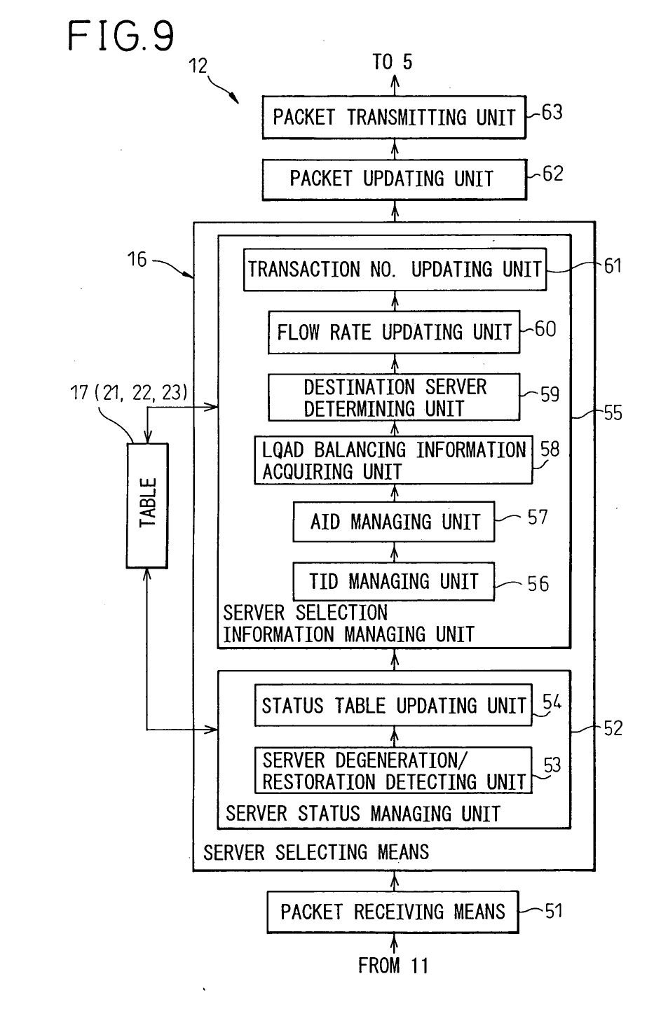

FIG. 7 is a functional block diagram of a packet distributing means 18 shown in FIG. 2; FIG. 8 is a functional block diagram of a packet analyzing means 15 shown in FIG. 2; and FIG. 9 is a functional block diagram of a server selecting means 16 shown in FIG. 2, which are only examples.

First, referring to FIG. 7, a packet arriving from the external network 2 is received by the packet receiving unit 31 and input to the packet allocating means 18.

The packet allocating means 18 first extracts the IP-source address (SA) from the received packet PK at an IP-SA acquiring unit 32. At the next hash computing unit 33, the extracted IP-SA is used for hash computation so that the received packet is routed to a different first load balancing apparatus (one of 11-1 to 11-N) in accordance with the IP-SA. Using the hash value obtained by this hash computation as a key, a hash table search unit 34 searches through the assignment table (not shown) and identifies the first load balancing apparatus for allocation to.

Therefore, the received packet PK is transmitted from a packet transmitting unit 35 to the identified first load balancing apparatus 11.

The received packet transmitted in this way is received by the packet receiving means 41 in the identified first load balancing apparatus 11 shown in FIG. 8 and input to the packet analyzing means 15.

The packet analyzing means 15 analyzes the data attribute (application and transaction) of the received packet. First, it inputs the received packet to an application analyzing unit 42. There, it is processed by a TCP/UDP port number acquiring unit 43 and AID acquiring unit 44.

That is, the application is identified from the TCP/UDP port number etc. and the AID corresponding to the application is acquired by searching through a table etc. That is, the TCP/UDP port number is converted to an AID.

The received packet assigned the AID is next input to a transaction analyzing unit 45 where it is processed by a transaction identifying unit 46, a transaction start/end deciding unit 47, and a transaction number managing unit 48.

That is, a transaction is discriminated for every application and a TID (temporary number) is determined.

A TID is assigned at the start of a transaction.

The same TID is used during the transaction.

The TID is released at the end of the transaction.

Therefore, the received packet processed by the packet analyzing means 15 is input to a packet updating unit 49 where the above identified AID, TID, and transaction end flag (TEF) are embedded in the received packet PK (see FIG. 3). The result is then output from the packet transmitting unit 50 to the second load balancing apparatus 12.

The packet output from the packet transmitting unit 50 in this way is received at the packet receiving unit 51 of FIG. 9 and input to a server selecting means 16.

In the server selecting means 16, the input packet is first supplied to a status managing unit 52 where it is processed by a server degeneration/restoration detecting unit 53 and a status table updating unit 54.

That is, degeneration and restoration of the server 5 are monitored. At the time of degeneration, a degeneration flag is set in the table B managing the statuses of the servers so that a degenerated server is not selected in the later explained destination server determining unit 59.

The packet processed by the server status managing unit 52 is next input to a server selection information managing unit 55. This managing unit 55 is comprised of the illustrated blocks 56 to 61 and determines the destination server 5 to be assigned for the packet based on the TID and AID notified from the previous apparatus 11 (FIG. 8).

First, the TID managing unit 56 determines from the TID if a transaction is starting or is in progress. If the transaction end flag (TEF) is ON, it deletes the TID from the table A.

The AID managing unit 57 identifies the group of servers able to provide a service from the AID.

The load balancing information acquiring unit 58 acquires the information on the flow rate and number of transactions at the time of start of the transactions.

The destination server determining unit 59 determines the destination server 5 from information obtained at the load balancing information acquiring unit 58 at the time of start of transactions. While a transaction is in progress, it determines the destination server 5 from the table A relating to the TID.

The flow rate updating unit 60 updates the flow rate information.

The transaction number updating unit 61 updates the transaction number information.

The packet finished being processed as explained above is stripped of the AID, TID, and transaction end flag (TEF) added to part of it at the packet updating unit 62, then is transmitted from the packet transmitting unit 63 to the destination server 5 for which assignment is decided.

The operation of the first, second, and third load balancing apparatuses 11, 12, and 13 configured as shown in FIG. 7 to FIG. 9 will be explained next.

If traffic for file transfer (FTP) and web access (http) occurs from the external network 2, the load balancing apparatus 13 balances the file transfer and web access traffic among the load balancing apparatuses 11-1 to 11-N based on the IP-SAs.

The apparatuses 11-1 to 11-N discriminate whether the traffic is file transfer traffic or web access traffic and determines the servers 5 able to process the same for each packet (designated as 5A* for file transfer and as 5B* for web access). Simultaneously, it discriminates the transactions.

The results of discrimination of the application, that is, the identification information (AID), and the results of discrimination of the transaction, that is, the discrimination information (TID), are added as additional information to the received packet, which is then transmitted to the load balancing apparatus 12.

The apparatus 12 determines if the TID is registered in the table A (FIG. 4) so as to determine if the transaction has already been allocated to a specific server or if the server has to be assigned now.

When it has already been allocated to a specific server, the IP-DA of the server is acquired from the table A (FIG. 4), processing for transmission is performed, and the flow rate information of the table C (FIG. 6) is updated.

When not yet allocated to a specific server, a list of servers and packet allocation information suited for each application are obtained from the table B (FIG. 5). For this, the IP-DA list acquired from the table B is used to search through the table C (FIG. 6) and determine the suitable server for transmission to, based on the packet allocation information suited for each application. Further, the transmission processing and flow rate information/transaction information (table C) are updated.

In the case of a file transfer (FTP) packet, the IP-DAs of the server A1 and server A2 and the weighting information which indicates that the flow rate is to be used for selection of the server, are acquired from the tables B and D (FIG. 5). Further, the IP-DAs of the server A1 and server A2 are used to search through the table C (FIG. 6) so that the packet is then transmitted to the server 5 indicating the smaller flow rate.

In the case of a web access (http) packet, the IP-DAs of the server B1 and the server B2 and the weighting information which indicates that the number of transactions is to be used for server selection, are acquired from tables B and D (FIG. 5). Further, the IP-DAs of the server B1 and server B2 are used to search through the table C (FIG. 6) so that the packet is transmitted to the server indicating the smaller number of transactions per second, under the conditions that the number of transactions do not exceed the limit of the number of transactions set in advance.

For example, when considering the case where requests for file transfer (FTP) to the server A1 comprise a large number of requests from narrow channels (flow rate of 100 Mbps) and the requests to the server A2 comprise a small number of requests from broad channels (flow rate of 700 Mbps), if judged from the number of transactions, when newly selecting a server, the server A2 is to be selected. However, for FTP, it is considered that the server processing will become a bottleneck more because of the flow rate than because of the number of transactions. Therefore, the server A1 is selected.

The above operation will be explained in a little more detail next.

First, a first load balancing apparatus 11, as explained above, discriminates the application, data attribute, etc. and assigns the same AID to packets having the same application and same data attribute.

Further, as explained above, it discriminates a transaction and assigns the same TID to the same transactions. Further, when a transaction end, it sets the transaction end flag to ON (TEF→“ON”).

Further, it adds the above AID, TID, and transaction end flag TEF to the packet as the already explained tags and transmits the result to the second load balancing apparatus 12.

This apparatus 12 initializes the table B (FIG. 5) and table C (FIG. 6) at the time of startup. Further, the table B registers all AIDs discriminated and assigned at the apparatuses 11. The IP-DAs of the servers able to process packets which have applications and data attributes corresponding to the AIDs are also registered in the table B.

Note that when the table B and table D are merged, the resultant second table 22 also registers weighting information on which allocation information to give priority to for each AID. This weighting information indicates that the number of octets allocated per second to be used when allocating applications which should stress throughput such as FTP. On the other hand, it indicates that the number of transactions started per second when allocating web access applications (http) which should require call processing capability.

The table C (FIG. 6) registers the IP-DAs of all servers and registers the number of transactions which the servers can process.

When the table C and table E are merged, the resultant third table 23 also registers an AID list linking the applications and data attributes able to be processed for each corresponding IP-DA.

The following explanation will be conducted while referring to a flow chart.

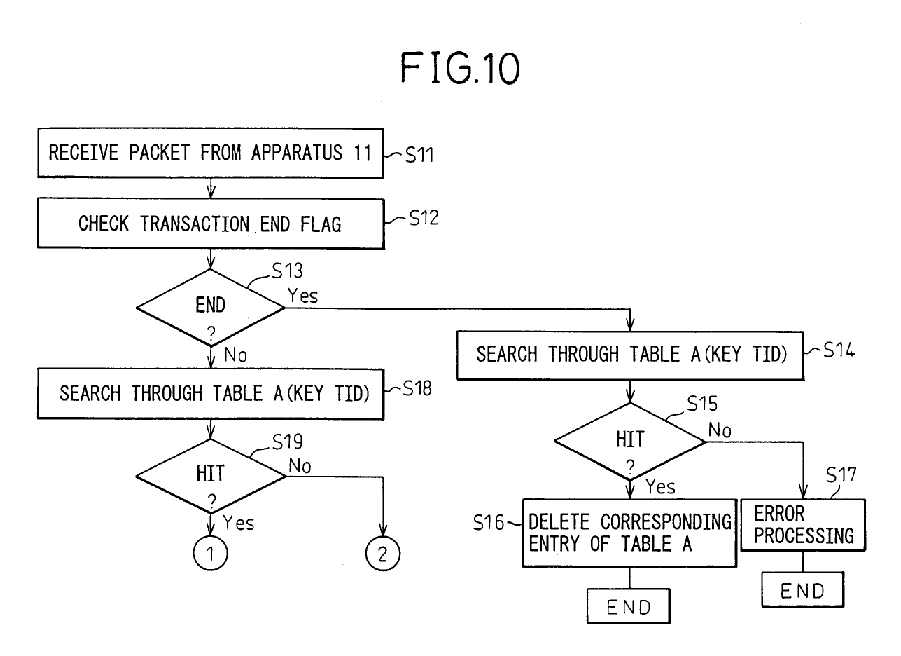

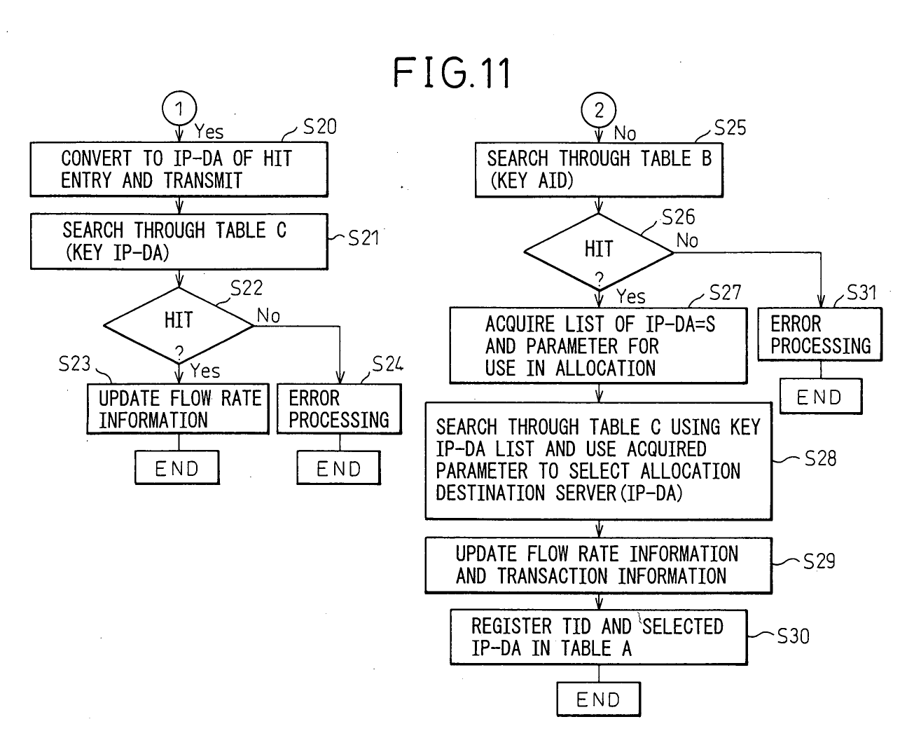

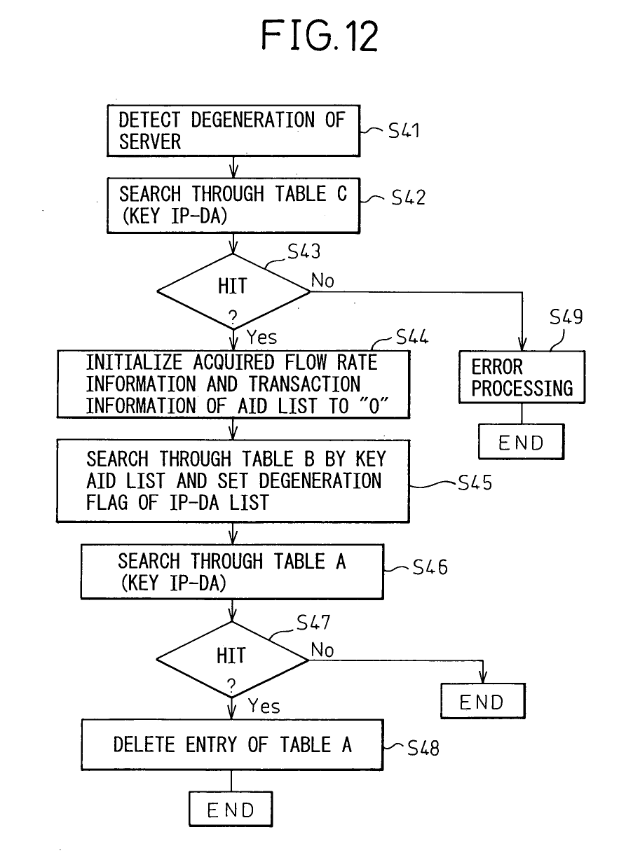

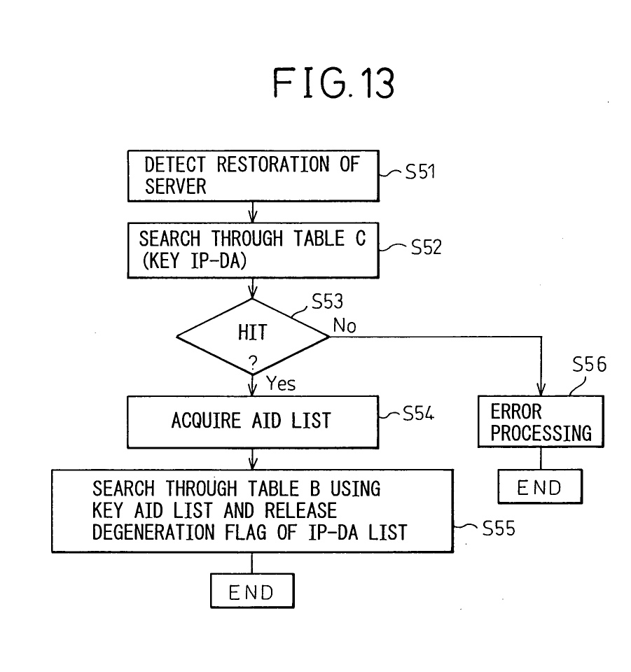

FIG. 10 is a first part of a flow chart of the operation of a load balancing apparatus 12 when receiving a packet from a load balancing apparatus 11; FIG. 11 is a second part of a flow chart of the operation of a load balancing apparatus 12 when receiving a packet from a load balancing apparatus 11; FIG. 12 is a flow chart of the operation of the load balancing apparatus 12 when a server has degenerated; and FIG. 13 is a flow chart of the operation of the load balancing apparatus 12 when a server has been restored from a degenerated state.

First, referring to FIG. 10, the second load balancing apparatus 12 receives a packet from the apparatus 11 (step S11).

It checks the transaction end flag (TEF) (S12). When the transaction has not yet ended (NO in S13), the apparatus 12 acquires the TID from the packet received from the corresponding apparatus 11 and uses that TID as a key to search through the table A (S18).

When that TID is registered in the table A (YES in S19), it judges that the transaction has started and transmits the packet stripped of the AID, TID, and transaction end flag (TEF) to the server having the IP-DA corresponding to that TID (S20).

After transmitting the packet, it uses the IP-DA of the destination as a key to search through the table C (S21). If that IP-DA produces a hit (YES in S22), it updates the information on the number of octets allocated per second of that entry (S23).

When the TID is not registered in the table A (NO in S19), it judges that the transaction has not been started. In this case, it uses the AID as a key to search through the table B (merged with table D) (S25). If producing a hit (YES in S26), it acquires a list of IP-DAs of servers able to process that packet and the allocation weighting information from the tables B and D (S27).

Next, it uses the IP-DAs as keys to search through the table C to acquire allocation information (S28). It then uses this information to select the optimum server as follows.

A server is not selected if the total number of started transactions is the number of transactions which that server can process. Further, when stressing throughput, such as with FTP, in accordance with the allocation weighting information, the server having the smallest number of octets allocated per second is selected. On the other hand, when stressing the call processing capability, such as with http, the server having the smallest number of transactions started per second is selected. The packet stripped of the AID, TID, and transaction end flag is transmitted to the IP-DA corresponding to the server selected in this way.

After transmitting the packet, the table A registers the TID and the IP-DA corresponding to the selected server (S30).

Note that the number of octets allocated per second, the number of transactions started per second, and the total number of transactions started, are updated for the entry of the table C corresponding to the IP-DA (S29).

The end of a transaction is determined by the transaction end flag (TEF). At the end of a transaction (YES in S13), the table A is searched through. If the ended TID produces a hit (YES in S15), that entry is deleted from table A (S16).

In table C, “1” is subtracted from the total number of the started transactions at the entry corresponding to the IP-DA for the ended TID.

Referring to FIG. 12, when detecting degeneration of a server (S41), the table C is searched through using the IP-DA of the degenerated server as a key (S42). If this key produces a hit (Yes in S43), the AID list corresponding to that key is acquired from the table E and the flow rate information and transaction information are initialized (S44). Further, the table B is searched through using each obtained AID as a key and the degeneration flag belonging to that IP-DA at the corresponding entry is set (S45).

Further, the table A is searched through (S46). If the IP-DA produces a hit (YES in S47), the corresponding entry is deleted from the table A (S48).

Finally, referring to FIG. 13, if a restoration of a server is detected in the second load balancing apparatus 12 (S51), the table C is searched through using the IP-DA of the server as a key (S52). If that IP-DA produces a hit (Yes in S53), the AID list of the table E is obtained (S54). The table B is searched through using this AID list as a key and the degeneration flag in the table B is turned to OFF (S55).

Summarizing the effects of the invention, as explained above, according to the present invention, by introducing the second load balancing apparatus 12, it is possible to realize the first load balancing apparatuses 11 without increasing the control traffic inside the system network and without increasing the servers unnecessarily.

While the invention has been described with reference to specific embodiments chosen for purpose of illustration, it should be apparent that numerous modifications could be made thereto by those skilled in the art without departing from the basic concept and scope of the invention.

What is claimed is:

1. A load balancing system provided with:
at least one first load balancing apparatus which analyzes higher layer information included in a received packet received from a client side to generate attribute information of the received packet and transmits the packet with the attribute information attached and
a second load balancing apparatus which monitors a state of traffic of packets transmitted to servers connected under it in correspondence with the servers, determines an optimum server for allocation of each packet based on the traffic state information and the attribute information transmitted from the corresponding first load balancing apparatus, and transmits the packet to the determined server.

2. A load balancing system as set forth in claim 1, comprising a plurality of first load balancing apparatuses and a second load balancing apparatus shared by the plurality of first load balancing apparatuses and further provided with a third load balancing apparatus for allocating said received packet in accordance with a predetermined algorithm to any of said plurality of first load balancing apparatuses.

3. A load balancing system as set forth in claim 1, wherein:
said first load balancing apparatus has a packet analyzing means,
said packet analyzing function unit generates identification information for identifying an application by said higher layer information and discrimination information for discriminating a series of transactions relating to the application, generates end information when the series of transactions ends, attaches the information to said received packet, and transmits the result to the second load balancing apparatus.

4. A load balancing system as set forth in claim 3, wherein said packet analyzing function unit assigns said discrimination information to said packet each time a series of transactions is started, uses the same discrimination information while a series of transactions is in progress, and releases said discrimination information when said series of transactions ends.

5. A load balancing system as set forth in claim 3, wherein:
said second load balancing apparatus has a server selecting function unit,
which server selecting means acquires statistical information relating to a flow rate of packets and a number of transactions as said traffic status information, identifies a group of servers able to execute said application based on the received identification information, determines the optimum destination server in the group of servers based on the statistical information, and sends the received packet to the destination server.

6. A load balancing system as set forth in claim 5, wherein said server selecting function unit acquires degeneration/restoration information relating to degeneration and restoration of the servers and excludes degenerating servers from coverage in the determination of the said destination server.

7. A load balancing system as set forth in claim 5, wherein said server selecting function unit determines said destination server from said discrimination information in accordance with whether a series of transactions has started, is in progress, or has ended.

8. A load balancing system as set forth in claim 5, wherein said server selecting function unit updates said traffic status information in accordance with any change in the traffic status.

9. A load balancing system as set forth in claim 3, wherein said server selecting function unit transmits a packet to the server side after stripping the attribute information, identification information, and end information added to the received packet.

10. A load balancing system as set forth in claim 6, wherein said server selecting function unit has various types of tables for storing various types of information required for identification of said group of servers and determination of said destination server.

11. A load balancing system as set forth in claim 10, wherein:
said various types of tables include a first table,
said first table indicates correspondence between said discrimination information finished being assigned and said destination servers starting said transactions.

12. A load balancing system as set forth in claim 11, wherein said correspondence is deleted from said first table when said end information is ON.

13. A load balancing system as set forth in claim 10, wherein:
said various types of tables include a second table,
said second table indicates correspondence between said identification information and said servers able to process said application.

14. A load balancing system as set forth in claim 13, which refers to said second table when said received packet has not yet been assigned said discrimination information.

15. A load balancing system as set forth in claim 13, wherein said second table also indicates said degeneration/restoration information of said servers able to process said application corresponding to said servers.

16. A load balancing system as set forth in claim 13, wherein said second table also indicates weighting information designating said statistical information to be stressed on a priority basis when determining said optimal destination server corresponding to said identification information.

17. A load balancing system as set forth in claim 10, wherein:
said various types of tables include a third table,
said third table indicates said statistical information corresponding to said destination servers and refers to the statistical information to assign a destination server with a small processing load when determining the optimal destination server.

18. A load balancing system as set forth in claim 17, wherein said third table is referred to when there is correspondence between said discrimination information finished being assigned and said destination server starting said transaction.

19. A load balancing system as set forth in claim 17, wherein said third table further indicates an identification information list corresponding to said destination servers and registers processable applications and data attributes for each destination server in said identification information list.
